(19) United States
(12) Patent Application Publication
(10) Pub. No.: US 2008/0317537 A1
(43) Pub. Date: Dec. 25, 2008

(54) Corn butterer

(75) Inventor: Eric J. Wangler, Mendon, NY (US)

Correspondence Address: LAW OFFICE OF JOHN C. MCMAHON, P.O. BOX 30069, KANSAS CITY, MO, 64112, US

(73) Assignee: Mary P. Crowley-Wangler, Mendon, NY (US)

(21) Appl. No.: 12/228,931

(22) Filed: Aug. 18, 2008

Related U.S. Application Data
(63) Continuation-in-part of application No. 11/370,340, filed on Mar. 8, 2006.

(51) Int. Cl. A46B 11/00; A46B 15/00; B05C 11/00

(52) U.S. Cl. 401/12; 401/82; 401/265

(57) ABSTRACT

A butterer for dispensing butter to hot corn on the cob. The butterer includes a body with a chamber that is filled with butter. The body also has salt and pepper dispensers. The body is ovate in cross section and shaped to conform to the hand of a user. A mechanical advantage pusher having a plunger is positioned over the butter in the chamber and allows a user to urge butter through the chamber. A lower grill resists direct contact of semisolid butter with the corn, but transfers heat from the corn and allows melted butter to pass to the corn. A stand and storage tray supports the butterer during non use and allows storage with butter therein in a refrigerator.

### CROSS-REFERENCE TO RELATED APPLICATIONS

This application is a continuation-in-part of U.S. patent application Ser. No. 11/370,340 filed Mar. 8, 2006, which is incorporated by reference herein.

### BACKGROUND OF THE INVENTION

An apparatus for use in applying butter to hot corn on the cob.

A favorite course at many meals, especially during certain summer months and among those who have home vegetable gardens, is corn on the cob, fresh from a boiling pan. Such corn is best when just picked before sugar content therein converts to starch. Most of those who like such corn, also like to apply butter and often salt and pepper.

Further, those who like buttered corn on the cob have partaken in the process of trying to apply butter from a knife to the corn. Because the butter applies best when melted on the corn, the pad of butter on the knife heats and becomes slidable along the knife, so it is very difficult to control and often falls from the knife. Some users even try to butter the corn by applying the cob directly to butter in a dish which both makes a mess and contaminates the butter.

Prior art devices have been made in an attempt to make a device that effectively applies the butter, but such often contaminate the butter, are difficult to clean, do not lend themselves to storage with butter therein, are likely to make a mess at the table and often allow the butter as a stick to slip from either end of the device without control. Some of the prior art devices do not work well with butter that is just taken from the refrigerator and is hard, so that it is difficult to feed through the butterer. The prior devices also are not able to work with “soft spread” type butter.

Consequently, applicant has developed a butterer to overcome these obstacles that is easily held and very user friendly. Further, applicant has developed such a butterer that preferentially includes integral salt and pepper shakers and a support and storage tray for holding the butterer when not in use. Still further, applicant provides a butterer that allows the user to easily control the feed of the butter, even hard butter or soft spread butter.

### SUMMARY OF THE INVENTION

A corn butterer includes a body that is ovate in cross section and designed to fit in the palm of the hand of a user during use, preferably being about three inches in height and being about two and a half by one and a half inches in width. The body includes a butter holding chamber that extends vertically and is sized and shaped to snugly but slidingly receive a pusher to urge the butter toward a dispensing grill.

The body is preferably in two securely joined parts with the butter preloaded inside.

The pusher is preferably a plunger like structure that is shaped to be slidingly received at one end of the butter holding chamber and is operably used to push the butter through and out of the chamber. The pusher is advanced and retracted in one embodiment by a screw that is in turn manually rotated by a user through a rotatable knob, but can be advanced by a ratchet mechanism or the like. The pusher provides mechanical advantage through the screw, so as to make dispensing of the butter easier for the user.

The body also includes a pair of dispensers on opposite sides of an upper end that receive salt and pepper for dispensing through associated dispensing apertures.

The bottom of the body is curved to fit the shape of an ear of corn. When used with the type of soft butter often referred to as “soft spread”, the bottom includes a grill that is preferably formed by a plurality of spaced apertures in the bottom surface of the body. The apertures or openings therein are sized sufficiently small to resist passage of semisolid butter, but allow flow of soft spread butter therethrough before and/or when heated by the corn. When used with hard butter, a grill is not required and pegs or pins are secured to the pusher that extend into the butter to hold the butter in the body.

A support and storage device or tray is also provided for the butterer. The storage tray has a generally flat bottom and upstanding sides that are sized and shaped to surround and snugly, but slidingly receive a lower end of the body. The storage tray receives the body during non use on the table to prevent dripping of butter onto unwanted areas and can be used to store the butterer with butter therein in the refrigerator.

After depletion of the butter in a butterer, it may be discarded and replaced by a new butterer. In some embodiments, the butterer may be refilled after depletion, especially when used with soft spread butter.

### OBJECTS AND ADVANTAGES OF THE INVENTION

Therefore, the objects of the present invention are: to provide a butterer that allows a user to easily and conveniently apply melted butter under control to hot corn on the cob while protecting the butter from direct contact with the user; to provide such a butterer having a body that is shaped to conveniently conform to the hand of the user; to provide such a butterer having a pusher for allowing a user to convey the butter along an interior chamber of the body, especially using a device to provide mechanical advantage, such as a screw and a user rotatable knob, to urge the pusher against one end of the butter; to provide such a butterer for use with soft spread butter having a grill that separates the butter from the corn and resists direct flow of semisolid butter onto the corn so that the butter does not become contaminated by the corn, but rather allows melted liquid butter to flow through the grill to the corn; to provide such a butterer with a cover and storage tray that receives a lower end of the butterer during non use to prevent dripping of butter therefrom onto the table or the like and that allows the butterer with butter therein to be stored in the refrigerator; and to provide such a butterer that is easy to use, relatively inexpensive to produce and especially well suited for the intended usage thereof.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a perspective view of a corn butterer in accordance with the present invention and a fragmentary ear of corn that is being buttered by the butterer.

FIG. 2 is a perspective view of the butterer nested in a storage tray.

FIG. 3 is a cross sectional view of the butterer, showing butter therein and taken along line 3-3 of FIG. 1.

FIG. 4 is a bottom plan view of the butterer with the tray removed.

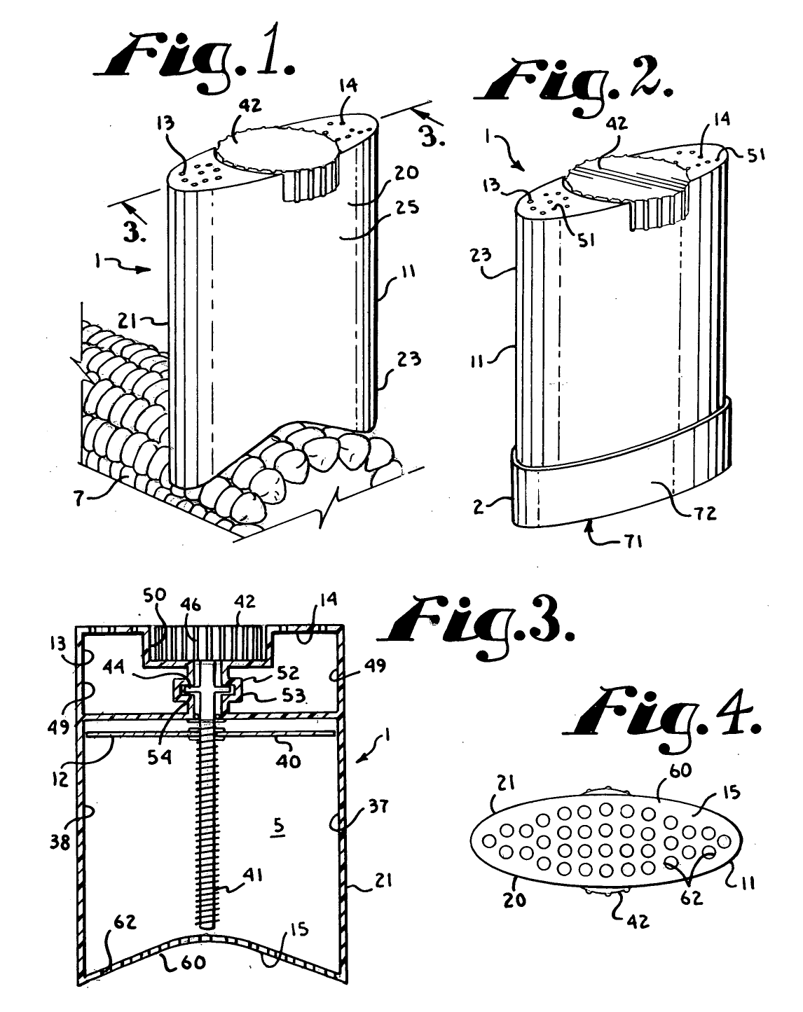

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The reference numeral 1 generally represents a butterer for corn on the cob and a mating support and storage tray 2. The butterer 1 is used in conjunction with butter 5 to butter an ear of corn 7.

The corn butterer 1 has a body 11, a pusher 12, a salt shaker 13, a pepper shaker 14 and a lower grill structure 15.

The body 12 is constructed in two mateable sections 20 and 21 that are secured together by gluing or the like. The body sections 20 and 21 join to form an operable carrier 23 for the butter 5 that has an outer grippable wall 25. The wall 25 is sized and shaped to be easily received in the hand of a user. The wall 25 has an ovate horizontal exterior cross section. As used herein, the terms horizontal, upper, top, lower, bottom and the like apply to the butterer 1 as shown in FIG. 3; however, it is seen that the butterer 1 can be held in other orientations, especially when using the salt shaker 13 and pepper shaker 14.

The body 11 also includes an interior chamber 37 formed by an interior wall 38. The chamber 37 is adjacent the grill structure 15 at the lower end thereof.

The pusher 12 includes a plunger or plate 40, a screw 41 and a knob 42. The plate 40 is a generally flat and horizontally positioned in the interior chamber 37. The plate 40 has the ovate shape of the body 11 and is sized and shaped to snugly, but slidingly, be received in the interior of the chamber 37 to slide vertically therein along the interior wall 38.

The plate 40 is mounted on the screw 41 so as to be driven upward or downward as the screw 41 is rotated counterclockwise or clockwise respectively. The screw 41 is fixed to the knob 42 so as to rotate coaxially therewith. The knob 42 has knurls or projections 46 therealong to allow a user to easily rotate the knob 42. The screw 41 includes a radially outward extending and generally cylindrical shaped position keeper structure 44 that functions to maintain the position of the screw 41 relative to the body 11 as the screw 41 rotates. The pusher 12 with the screw 41 provides a mechanical advantage to the user to make advancement of the plunger 40 easier. It is foreseen that such a mechanical advantage or advancement could be provided by other structures including ratchets.

The body 11 has a recess 50 that receives the knob 42 and allows the knob 42 to extend laterally outward on either side of the body 11 to be rotated by a user's thumb or finger.

The body 11 also has interior walls 52 located between the salt shaker 13 and pepper shaker 14. The walls 52 have structure 53 that forms an interior cylindrical shaped chamber 54. The chamber 54 receives and allows rotation of the cylindrical keeper structure cylinder 44 that projects from the screw 41. In this way, as the screw 41 rotates due to rotation of the knob 42, the keeper structure cylinder 44 keeps the screw 41 in approximately the same vertical position relative to the body 11 while causing the plate 40 to move either upward or downward relative to the body 11 depending upon the direction of rotation of the knob 42.

The salt shakers 13 and pepper shakers 14 each have an interior chamber 49 for the salt and pepper and dispensing apertures 51.

The body 11 has a curvate bottom wall 60 that includes the grill 15. The grill 15 has a plurality of pass through apertures or openings 62 arranged in a field sized and shaped to allow passage of liquid butter, especially butter of the type often referred to as “soft spread”, therethrough, but to resist flow of semisolid butter. The bottom surface 60 is arcuate so as to generally conform to the shape of the ear of corn 7.

It is foreseen that a dispenser for hard butter may or may not include a grill. In some instances the lower end may simply have an opening from which the hard butter extends. Where no grill is used, it is preferable to have short pegs or pins that extend from the pusher to help maintain the hard butter within the dispenser except for a small protruding portion.

The tray 2 functions as a receiver for supporting the butterer 1 when not in use at the table and further for storing the butterer 1 with butter 5 therein in a refrigerator between corn eating meals. The tray 2 includes a flat and solid lower or bottom wall 71 and an upstanding side wall 72 sealably received and secured around the periphery of the bottom wall 71 to form a butter holding structure. The side wall is sized to slidingly but snugly receive a lower portion of the butterer external wall 25 therein.

The butterer 1 is used by placing the grill 15 over the corn 7 so that butter 5 near the grill 15 is heated by the hot corn 7, such that the butter 5 partly melts and flows through the grill 15 onto the corn 7 while being urged toward the drills by the pusher 12.

After the chamber 37 is empty of butter 5, the butterer 1 is disposed of and replaced by a new butterer 1.

It is to be understood that while certain forms of the present invention have been illustrated and described herein, it is not to be limited to the specific forms or arrangement of parts described and shown.

What is claimed and desired to be secured by Letters Patent is as follows:

1. A hand held corn butterer comprising:
a) a body for holding in the hand of a user; the body having an arcuate bottom sized and shaped to generally mate with an ear of corn;
b) a chamber located in the body having top and bottom ends;
c) butter filling the chamber;
d) a pusher located within said chamber and having a plunger initially located in the chamber upper end and driven by an user manipulated device to urge the butter downward in the chamber; and
e) a dispenser at the lower end of the chamber and receiving the butter from the chamber for dispensing to the corn.

2. The butterer according to claim 1 wherein:
a) the dispenser includes a dispensing grill comprising a plurality of apertures formed in the body bottom so as to prevent the passage of solid butter from the chamber, but to allow non solid butter to pass through the apertures onto corn.

3. The butterer according to claim 1 wherein:
a) the body is sized and shaped to be received in the hand of a user during usage.

4. The butterer according to claim 1 wherein:
a) the body is ovate in horizontal cross section and the pusher plunger has a peripheral shape that generally mates with an interior of the body.

5. The butterer according to claim 1 wherein:
a) the pusher device provides a mechanical advantage to the user and is centrally and vertically extending; and
b) an actuator knob having a radius greater than the screw and that is coaxially fixed to an upper end of the screw to allow rotation of the screw.

6. The butterer according to claim 1 wherein:
a) the body includes a positioning structure chamber; and
b) the screw includes a radially outward projection that is operably captured in the positioning structure to prevent substantial movement of the screw axially relative to the body during rotation of the screw.

7. The butterer according to claim 1 wherein:
a) said body includes at least one condiment dispenser located adjacent to an upper end of the body.

8. The butterer according to claim 7 wherein:
a) said dispenser is a first dispenser and including a second dispenser located in said body opposite said first dispenser at the top end of said body wherein said first dispenser is adapted for salt and said second dispenser is adapted for pepper.

9. The butterer according to claim 1 including:
a) a receiver and storage tray for receiving and storing the butterer body during non use.

10. The butterer according to claim 9 wherein:
a) said tray includes a generally flat bottom wall sealably secured to a surrounding upstanding side wall that is sized and shaped to snugly, but slidingly, receive a lower end of the body therein.
